(19) United States
(12) Patent Application Publication
(10) Pub. No.: US 2003/0081959 A1
(43) Pub. Date: May 1, 2003

(54) Electrophotographic printer

(75) Inventor: Chihiro Komori, Yokohama (JP)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/266,920

(22) Filed: Oct. 9, 2002

(30) Foreign Application Priority Data
Oct. 9, 2001 (JP) 2001-311366

(51) Int. Cl. G03G 15/02

(52) U.S. Cl. 399/50

(57) ABSTRACT

An electrophotographic printer maintains a surface potential of a photosensitive drum at a constant value even when a photosensitive layer corresponding to a surface of the photosensitive drum wears down. The electrophotographic printer includes a charging power supply, a charging roller, a photosensitive drum, an erasing unit, a charging current observation unit, an arithmetic and control unit, and a memory unit. The arithmetic and control unit rotates the photosensitive drum a plurality of times while the erasing unit is turned off during an initial operation of the electrophotographic printer, controls the charging power supply to generate a charging voltage, adds values of the charging current while the photosensitive drum rotates a plurality of times, and stores a result of an addition of the values in the memory unit. During an actual printing process, the arithmetic and control unit rotates the photosensitive drum while the erasing unit is turned on, and controls the charging voltage output from the charging power supply so that a charging current is equal to the result of the addition stored in the memory unit.

### CROSS-REFERENCE TO RELATED APPLICATIONS

This application claims the benefit of Japanese Patent Application No. 2001-311366, filed Oct. 9, 2002, in the Japanese Patent Office, the disclosure of which is incorporated herein by reference.

### BACKGROUND OF THE INVENTION

1. Field of the Invention

The present invention relates to an electrophotographic printer, and more particularly, to an apparatus for charging a photosensitive drum in an electrophotographic printer during an initial printing process.

2. Description of the Related Art

A printing process includes a first operation of charging a photosensitive drum. In order to improve a printing quality, after the charging operation, a surface potential of the photosensitive drum needs to be maintained at a constant value.

In order to maintain the surface potential of the photosensitive drum at the constant value, a surface potential sensor measuring the surface potential of the photosensitive drum is provided so that an amount of electrical charges transmitted to a surface of the photosensitive drum can be controlled according to a result of detection of the surface potential sensor. Since the surface potential sensor is usually expensive, an overall printer cost is high.

Accordingly, in the prior art, a charging current used to charge the surface of the photosensitive drum is controlled to maintain the constant value. Through the control of the charging current, even when a resistance of a charging roller transmitting a charging current, i.e. electrical charges, onto the surface of the photosensitive drum varies according to a temperature or humidity, the surface potential of the photosensitive drum can be maintained at the constant value.

However, as shown in FIG. 1, when a photosensitive layer corresponding to the surface of the photosensitive drum wears down, a thickness of the photosensitive layer decreases, and an electrostatic capacity of the photosensitive layer increases. In this case, even if the charging current is maintained at the constant value, the surface potential of the photosensitive drum reduces and it cannot be maintained at the constant value.

### SUMMARY OF THE INVENTION

To solve the above and other problems, it is an object of the present invention to provide an electrophotographic printer which can maintain a surface potential of a photosensitive drum at a constant value even when a photosensitive layer corresponding to a surface of the photosensitive drum wears down.

Additional objects and advantageous of the invention will be set forth in part in the description which follows and, in part, will be obvious from the description, or may be learned by practice of the invention.

Accordingly, to achieve the above and other objects, there is provided an electrophotographic printer. The electrophotographic printer includes a charging power supply which generates a variable charging voltage, a charging roller to which the charging voltage generated by the charging power supply is supplied, a photosensitive drum charged by the charging roller, an erasing unit discharging the charged photosensitive drum, a charging current observation unit detecting a value of a charging current flowing between the charging power supply and the charging roller, an arithmetic and control unit which controls the charging voltage generated by the charging power supply, a rotation of the photosensitive drum, and the erasing unit, and receives the value of the charging current detected by the charging current observation unit, and a memory unit connected to the arithmetic and control unit.

The arithmetic and control unit rotates the photosensitive drum a plurality of times while the erasing unit is turned off during an initial operation of the electrophotographic printer, controls the charging power supply to generate the charging voltage, adds values of the charging current detected by the charging current observation unit while the photosensitive drum rotates a plurality of times, and stores a result of addition of the values of the charging current in the memory unit, and during an actual printing process, the arithmetic and control unit rotates the photosensitive drum during a state when the erasing unit is turned on, and controls the charging voltage output from the charging power supply so that the charging current detected by the charging current observation unit is equal to the result of the addition stored in the memory unit.

The arithmetic and control unit stores another value obtained by subtracting an error current value with respect to the charging current from the result of the addition in the memory unit.

The arithmetic and control unit rotates the photosensitive drum twice during the initial operation of the electrophotographic printer, controls the charging power supply to generate the charging voltage, and stores another value which corresponds to a ratio of a first charging current to a second charging current in the memory unit, wherein the first charging current is detected by the charging current observation unit, which corresponds to a first rotation of the photosensitive drum, and the second charging current is detected by the charging current observation unit, which corresponds to a second rotation of the photosensitive drum.

### BRIEF DESCRIPTION OF THE DRAWINGS

These and other objects and advantageous of the invention will become apparent and more readily appreciated from the following description of the preferred embodiments, taken in conjunction with the accompanying drawings of which:

FIG. 1 is a table showing wear of a photosensitive layer corresponding to a surface of a photosensitive drum in terms of layer thickness and surface potential;

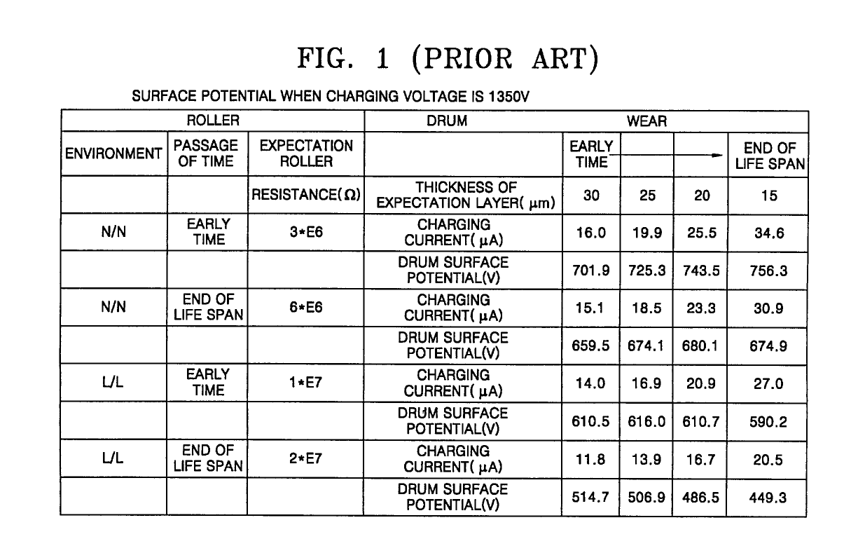

FIG. 2 illustrates a structure of an electrophotographic printer according to an embodiment of the present invention;

FIG. 3 shows a circuit diagram equivalent to a system charging a surface of a photosensitive drum during an initial printing process in the electrophotographic printer shown in FIG. 2;

FIG. 4 is a graph illustrating how a charging current decreases in time; and

FIG. 5 is a graph showing a total charging current versus time when a leakage current exists.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

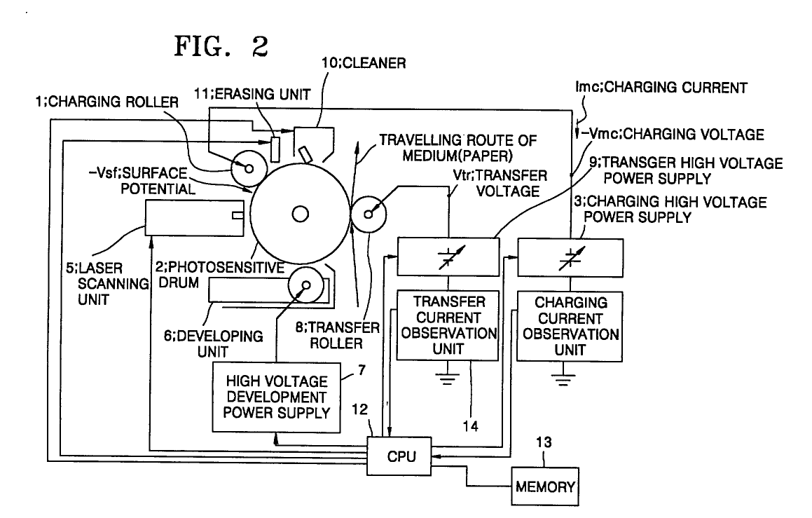

FIG. 2 illustrates a structure of an electrophotographic printer according to an embodiment of the present invention. A charging roller 1 charges a surface of a photosensitive drum 2 during an initial printing process. Accordingly, a charging high voltage power supply 3 which supplies first electrical charges, i.e. a charging current Imc, is connected to the charging roller 1, and a charging current observation unit 4 detecting the charging current Imc is connected between the charging high voltage power supply 3 and a ground potential. The charging current observation unit 4 may also be connected between the charging roller 1 and the charging high voltage power supply 3.

A laser scanning unit (LSU) 5 radiates a laser beam onto the charged surface of the photosensitive drum 2 to partly reduce a surface potential of the charged photosensitive drum 2, thereby forming an electrostatic latent image on the charged surface of the photosensitive drum 2. A developing unit 6 develops the electrostatic latent image with charged toner, which is transferred to a portion of the surface of the photosensitive drum 2, onto which the laser beam is radiated, through the electrical charges supplied from a high voltage development power supply 7. That is, since there are no electrical charges in the portion to which the laser beam is radiated, a repelling force between the charged toner and the portion does not occur, and thus the charged toner is attached to the portion.

A transfer roller 8 transfers the toner from the surface of the photosensitive drum 2 onto paper. For this purpose, the transfer roller 8 is connected to a transfer high voltage power supply 9 which generates a transfer voltage Vtr, and thus attaches the charged toner onto the paper from the surface of the photosensitive drum 2 by the transfer voltage Vtr.

A cleaner 10 removes residual toner remaining on the surface of the photosensitive drum 2 after the charged toner is transferred onto the paper. An erasing unit 11 removes the electrical charges on the surface of the photosensitive drum 2.

A CPU (arithmetic and control unit) 12 controls the charging high voltage power supply 3, the LSU 5, the high voltage development power supply 7, the transfer high voltage power supply 9, the cleaner 10, and the erasing unit 11. In addition, a memory unit 13 is connected to the CPU 12.

A charging voltage −Vmc as an output voltage of the charging high voltage power supply 3, and the transfer voltage Vtr as an output voltage of the transfer high voltage power supply 9 may vary by a command from the CPU 12. The CPU 12 performs an arithmetic operation, which will be described later, according to the charging current Imc detected by the charging current observation unit 4. And the CPU 12 controls the charging high voltage power supply 3 to change (adjust) the charging voltage −Vmc. As the charging voltage −Vmc is changed, the charging current Imc varies. In addition, although not shown, the CPU 12 switches on and off of a rotation of the photosensitive drum 2.

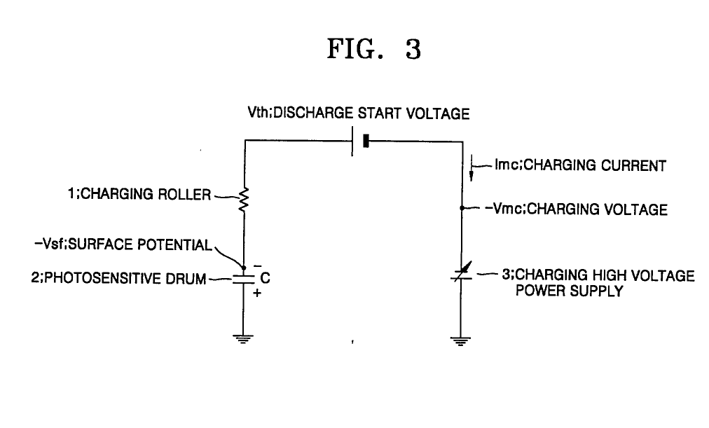

FIG. 3 shows a circuit diagram equivalent to a system for charging the surface of the photosensitive drum 2 during the initial printing process. A resistor R represents the charging roller 1, and a capacitor C represents the photosensitive drum 2.

An initial operation performed during warming up immediately after the electrophotographic printer is turned on, will be described with reference to FIGS. 2 and 3. In addition, it is assumed that the photosensitive drum 2 rotates continuously. First, the erasing unit 11 of FIG. 2 is turned on by the CPU 12, and thus the electrical charges on the surface of the photosensitive drum 2 are removed. With respect to FIG. 3, the removing of the electrical charges on the surface of the photosensitive drum 2 means that the electrical charges of the capacitor C representing the photosensitive drum 2 are discharged and become zero.

Next, the erasing unit 11 is turned off, and new electrical charges are transmitted to the surface of the photosensitive drum 2 from the charging high voltage power supply 3 through the charging roller 1, and thus the surface of the photosensitive drum 2 is charged. That is, the charging current Imc is generated by the charging high voltage power supply 3 which generates the charging voltage −Vmc. In this case, if it is assumed that the surface potential of the photosensitive drum 2 is −Vsf and a discharge start voltage is Vth, the charging voltage −Vmc is set to a target value of (−Vsf−Vth). In the circuit diagram of FIG. 3, the charging current Imc is reduced as the charging of the capacitor C is completed. Since the capacitor C charges and discharges repeatedly in the same manner as the photosensitive drum 2 charges and discharges while rotating, the charging current Imc flows continuously. In the present description, the charging current Imc will be described on the basis of the circuit diagram of FIG. 3.

As the charging of the surface of the photosensitive drum 2 is performed, that is, as the charging of the capacitor C is performed in FIG. 3, the surface potential −Vsf of the photosensitive drum 2 approaches −(Vmc−Vth), and thus the charging current Imc decreases. If the surface potential −Vsf of the photosensitice drum 2 is equal to −(Vmc−Vth), the charging current Imc is zero.

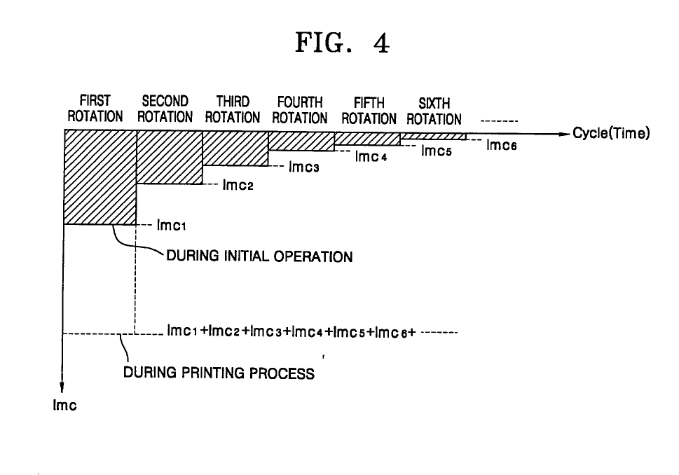

FIG. 4 is a graph showing how the charging current Imc decreases in time. The charging current Imc is detected by the charging current observation unit 4. And then, a total charging current which flows until the charging current Imc becomes zero, is calculated by the CPU 12.

Also, during an actual printing process, the erasing unit 11 is turned on, and the charging current Imc is set so that the total charging current calculated during the initial operation flows while the photosensitive drum 2 rotates once. Specifically, the CPU 12 controls the charging voltage −Vmc output from the charging high voltage power supply 3 while observing the charging current Imc detected by the charging current observation unit 4. In an example shown in FIG. 4, during the actual printing process, the charging current Imc is obtained by Equation 1 as follows.

Imc=Imc₁+Imc₂+Imc₃+Imc₄+Imc₅+Imc₆+ (1)

Then, while the photosensitive drum 2 rotates once, a desired surface potential can be obtained by charging the surface of the photosensitive drum 2 (charging the capacitor C).

However, acutally, there is leakage current caused by the photosensitive drum 2 or a moisture attached onto the surface of the photosensitive drum 2 or the charging roller 2. In this case, during the initial operation, the charging current Imc is not permanently equal to zero, and an error on the total charging current increases by an addition of the leakage current.

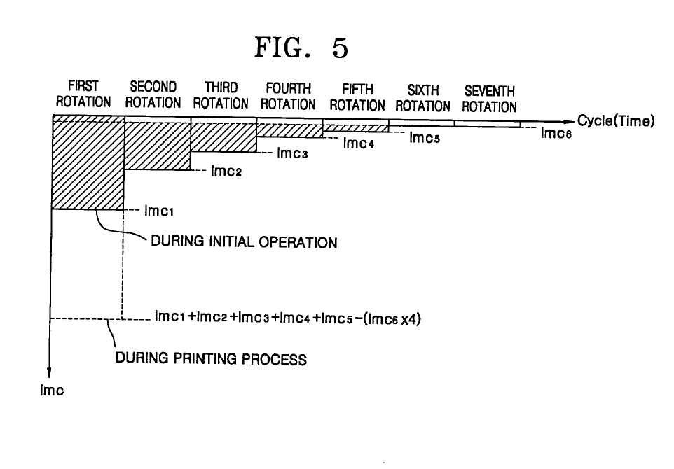

FIG. 5 is a graph showing the total charging current versus time when leakage current exists. In this case, when the charging current Imc is not reduced, the charging of the photosensitive drum 2 (charging of the capacitor C) is terminated, and the leakage current added repeatedly to the charging current is subtracted from the total charging current. In an example shown in FIG. 5, since the charging currents corresponding to the sixth and seventh rotation of the photosensitive drum 2 are equal to each other, the charging of the photosensitive drum 2 (charging of the capacitor C) is terminated. Also, the total charging current, that is, the charging current Imc during the actual printing process is calculated by Equation 2, and the leakage current added repeatedly to the charging current is subtracted from the total charging current.

Imc=Imc₁+Imc₂+Imc₃+Imc₄+Imc₅−(Imc₆×4) (2)

Next, the electrophotographic printer according to another embodiment of the present invention will be described. During the initial operation in the above-mentioned structure of the electrophotographic printer of FIG. 2, the charging of the photosensitve drum 2 (charging of the capacitor C) is performed continuously until the charging current Imc becomes zero or only the leakage current, and thus a long period of time for the initial operation may be required. Accordingly, in this embodiment, during the initial operation, the photosensitive drum 2 rotates only twice, and the total charging current is estimated from a ratio of the charging current Imc₁ to the charging current Imc₂ (where Imc₁ corresponds to a first rotation of the photosensitive drum 2 and Imc₂ corresponds to a second rotation of the photosensitive drum 2), as shown in FIG. 3. That is, a time constant CR of the circuit diagram shown in FIG. 3 is obtained from the ratio of the charging current Imc₁ to the charging current Imc₂, and the total charging current is estimated using the obtained time constant CR. In this way, the time required during the initial operation can be reduced.

As described above, according to the present invention, the surface potential of the photosensitive drum can be maintained at a desired constant value without using a high-priced surface potential sensor. As such, the surface potential of the photosensitive drum can be maintained at a constant value without increasing a manufacturing cost. In particular, even when the surface of the photosensitive drum wears down, the surface potential of the photosensitive drum can be maintained during a life span of the photosensitive drum. As a result, the electrophotographic printer can maintain a printing quality of a picture until the end of the life span of the photosensitive drum.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. An electrophotographic printer comprising:
a charging power supply which generates a variable charging voltage;
a charging roller to which the charging voltage generated by the charging power supply is supplied;
a photosensitive drum charged by the charging roller;
an erasing unit discharging the charged photosensitive drum;
a charging current observation unit detecting a value of a charging current flowing between the charging power supply and the charging roller;
an arithmetic and control unit controlling the charging voltage generated by the charging power supply, a rotation of the photosensitive drum, and the erasing unit, and receiving the value of the charging current detected by the charging current observation unit; and
a memory unit connected to the arithmetic and control unit;
wherein the arithmetic and control unit rotates the photosensitive drum a plurality of times while the erasing unit is turned off during an initial operation of the electrophotographic printer, controls the charging power supply to generate the charging voltage, adds values of the charging current detected by the charging current observation unit while the photosensitive drum rotates a plurality of times, and stores a result of the addition of the values in the memory unit, and during an actual printing process of the electrophotographic printer, the arithmetic and control unit rotates the photosensitive drum during a state when the erasing unit is turned on, and controls the charging voltage output from the charging power supply so that the charging current detected by the charging current observation unit is equal to the result of the addition of the values stored in the memory unit.

2. The printer of claim 1, wherein the arithmetic and control unit stores another value obtained by subtracting an error current value with respect to the charging current from the result of the addition of the values in the memory unit.

3. The printer of claim 1, wherein the arithmetic and control unit rotates the photosensitive drum twice during the initial operation of the electrophotographic printer, controls the charging power supply to generate the charging voltage, and stores another value which corresponds to a ratio of a first charging current to a second charging current in the memory unit, wherein the first charging current is detected by the charging current observation unit, which corresponds to a first rotation of the photosensitive drum and the second charging current is detected by the charging current observation unit, which corresponds to a second rotation of the photosensitive drum.

4. An electrophotographic printer having a scanning unit, comprising:
a charging power supply which generates a charging voltage;
a charging roller supplied with the charging voltage generated by the charging power supply;
a photosensitive drum charged by the charging roller and scanned by the scanning unit after being charged by the charging roller;
a charging current observation unit detecting a value corresponding to a charging current flowing between the charging power supply and the charging roller; and
an arithmetic and control unit controlling the charging roller to change the charging voltage in response to the value of the charging current detected by the charging current observation unit.

5. The printer of claim 4, further comprising:
a memory connected to the arithmetic and control unit to store the value.

6. The printer of claim 4, wherein the arithmetic and control unit does not measure a surface potential of the photosensitive drum.

7. The printer of claim 4, wherein the arithmetic and control unit is not disposed between the charging roller and the photosensitive drum.

8. The printer of claim 4, wherein the charging current observation unit is connected between the charging roller and a potential.

9. The printer of claim 4, wherein the charging current observation unit is connected between the charging roller and the charging power supply.

10. The printer of claim 4, further comprising:
a transfer voltage power supply generating a transfer voltage;
a transfer roller disposed to feed a sheet with the photosensitive drum to transfer a print image from the photosensitive drum to the sheet in response to the transfer voltage of the transfer voltage power supply; and
a transfer current observation unit detecting a transfer voltage supplied from the transfer voltage power supply to the transfer roller, wherein the arithmetic and control unit controls the transfer voltage power supply to change the transfer voltage in response to the detected transfer voltage.

11. The printer of claim 4, wherein the arithmetic and control unit calculates a total charging current in response to the value and controls the charging power supply to supply a second charging voltage to the charging roller in response to the total charging current.

12. The printer of claim 11, wherein the charging current decreases to current values corresponding to unit times until the charging current becomes an ending current in time, and the total charging current is a sum of the charging current and the current values.

13. The printer of claim 12, wherein the ending current is zero.

14. The printer of claim 4, wherein the arithmetic and control unit calculates a total charging current from the value during a first rotation of the photosensitive drum and controls the charging power supply to supply a second charging voltage to the charging roller in response to the total charging current during a second rotation of the photosensitive drum.

15. The printer of claim 4, wherein the arithmetic and control unit determines the charging current according to a formula Imc=Imc₁+Imc₂+Imc₃+Imc₄+Imc₅+Imc₆+ . . . +Imcₙ where Imc is a total charging current and n is a positive natural number corresponding to each rotation of the photosensitive drum.

16. The printer of claim 15, wherein the arithmetic and control unit controls the charging power supply to supply a second charging voltage to the charging roller in response to the total charging current.

17. The printer of claim 4, wherein the arithmetic and control unit determines the charging current according to a formula Imc=Imc₁+Imc₂+Imc₃+Imc₄++ . . . +Imcₙ₋₁−(Imcₙ×(n−2)) where Imc is a total charging current and n is a positive natural number corresponding to each rotation of the photosensitive drum.

18. The printer of claim 4, wherein the charging current observation unit detects a first charging current corresponds to a first rotation of the photosensitive drum to a second charging current corresponding to a second rotation of the photosensitive drum, and arithmetic and control unit determines another value which corresponds to a ratio of the first charging current to the second charging current and controls the charging power supply to supply the charging voltage to the charging roller in response to another value.

19. A method in an electrophotographic printer having a scanning unit, the method comprising:
detecting a value corresponding to a charging current flowing from a charging power supply to a charging roller charging a photosensitive drum to be scanned by the scanning unit after being charged by the charging roller; and
controlling the charging roller to change the charging voltage in response to the value of the charging current detected by the charging current observation unit.

20. The method of claim 19, wherein the controlling of the charging roller comprises:
calculating a total charging current from the charging current; and
controlling the charging roller to change the charging voltage in response the total charging current.

21. The method of claim 20, wherein the detecting of the value and the controlling of the charging roller comprise:
detecting the value during a first rotation of the photosensitive drum; and
controlling the charging roller to generate a second charging voltage to be supplied from the charging power supply to the charging roller during a second rotation of the photosensitive drum in response to the total charging current.
